(19) United States
(12) Patent Application Publication
(10) Pub. No.: US 2012/0156345 A1
(43) Pub. Date: Jun. 21, 2012

(54) BOTTLE TOP AERATOR

(76) Inventors: Dhruv Agarwal, Seattle, WA (US); Amy Lin, Lacey, WA (US)

(21) Appl. No.: 13/332,057

(22) Filed: Dec. 20, 2011

Related U.S. Application Data
(60) Provisional application No. 61/425,188, filed on Dec. 20, 2010.

(51) Int. Cl. C12G 1/00; B01F 3/04

(52) U.S. Cl. 426/474; 261/116

(57) ABSTRACT

A method and apparati to exploit a bottle mounted housing, defining a liquid passageway for a liquid flow from the bottle. A funnel coaxially situated to the liquid flow and extending from a funnel inlet converging in a downstream direction at a funnel outlet joins a bowl coaxially situated to the liquid flow and converging in the downstream direction at a bowl outlet. A horn extends from the bowl outlet and flares downstream to a horn outlet having a greater cross-sectional area than that of the bowl outlet. At least one barrel has a barrel lumen extending from a barrel inlet to a barrel outlet at an acute angle to the liquid flow to admit an airflow through the lumen and into the bowl. A resilient sealing gasket including at least one annular flange, is removable engaged with an opening in a bottle for pouring liquid from the bottle.

### PRIORITY CLAIM

The Applicant claims priority to U.S. Provisional Patent Application 61/425,188 filed on Dec. 20, 2010 incorporated herein fully by this reference.

### FIELD OF THE INVENTION

The field of invention comprises aeration of beverages containing tannin, more specifically the bottle top aeration of such beverages.

### BACKGROUND OF THE INVENTION

The hospitality industries have made bottle mounted pour spouts or “pourers”, a fixture of the suitably appointed bar. In the most rudimentary mode, bottle-mounted pourers have allowed dispensing of bottled beverages with minimal spillage. Such dispensers include a cork surrounding a formed pour tube to serve as a conduit for the beverage out of the bottle and into a glass. A vent admits air from the ambient atmosphere back into the bottle to make the beverage flow through the pour tube more natural by preventing a vacuum from forming behind the poured liquid within the bottle.

On May 27, 2003, the United States Patent and Trademark Office issued U.S. Pat. No. 6,568,660 to Torben Flanbaum for a “Pourer for Simultaneously Pouring Liquid from a Container and Mixing Air into the Liquid.” The patent described “A pourer (101) for simultaneously pouring a liquid from a container and mixing air into the liquid. The pourer comprises an elongated annular body (102) which defines an outer surface having a part (103) which is adapted to be fitted into an opening of the container. The annular body defines a longitudinally extending through-going channel (104) and has an air intake opening (106) extending transversely to the channel and penetrating the body, so as to allow air to be sucked into the channel when liquid is flowing from the container through the channel. The channel defines a contraction (105) near the air intake opening, so as to generate a low pressure in the area of the contraction when liquid is flowing through the channel and thereby assist in sucking air into the channel through the air intake opening. A screen (107) with perforations (108) may be provided inside the channel (104).” [Abstract.]

The Flanbaum patent, however, does not achieve optimal mixing because of the insistence of its teaching that air enters the through-going channel transversely. While air has much less mass per unit volume than does the liquid, it does have mass and thus, upon collision with liquid, the flow of that air introduces turbulence in the flow of liquid through the through-going channel. As such, the mixture of aerated and nonaerated liquid in the through-going channel downstream of the constriction is neither uniform nor optimal.

Additionally, as there is no vent to aid the flow of liquid through the through-going channel through the Flanbaum pourer the liquid flow is impeded by formation of a vacuum within the container. The nonuniform flow of liquid causes a nonuniform drop in pressure at the constriction of the venturi causing further nonuniformity in aeration as the liquid passes down the through-going channel.

The lack of any stopping means within the Flanbaum pourer requires its removal from the bottle for recorking upon storage. Thus, the on-bottle nature of the pourer is only advantageous during serving or decanting. The Flanbaum pourer will not facilitate serving less than the entirety of the bottle and the teaching specifically refers to is use for decanting confirming the lack of utility for storage.

There exists, then, the opportunity to exploit the movement of the beverage within a pour tube to aerate the beverage for service in the context of the hospitality industries. The current art lacks a convenient variable aerator for enhancement of wine.

### SUMMARY OF THE INVENTION

A method and apparati to exploit a bottle mounted housing, defining a liquid passageway for a liquid flow from the bottle. A funnel coaxially situated to the liquid flow and extending from a funnel inlet converging in a downstream direction at a funnel outlet joins a bowl coaxially situated to the liquid flow and converging in the downstream direction at a bowl outlet. A horn extends from the bowl outlet and flares downstream to a horn outlet having a greater cross-sectional area than that of the bowl outlet. At least one barrel has a barrel lumen extending from a barrel inlet to a barrel outlet at an acute angle to the liquid flow to admit an airflow through the lumen and into the bowl. A resilient sealing gasket including at least one annular flange, is removable engaged with an opening in a bottle for pouring liquid from the bottle.

### BRIEF DESCRIPTION OF THE DRAWINGS

Preferred and alternative examples of the present invention are described in detail below with reference to the following drawings:

FIG. 1 depicts an isometric view of aerating pourer in a first embodiment (bottle shown in phantom);

FIG. 2 depicts a cross-sectional view of the first embodiment taken at a first section to show the barrel;

FIG. 3 depicts a cross-sectional view of the first embodiment taken at a second section to show the vent lumen;

FIG. 4 depicts an isometric view of aerating pourer in a second embodiment (bottle shown in phantom); and

FIG. 5 depicts a cross-sectional view of the second embodiment taken at a section to show the barrel.

### DETAILED DESCRIPTION OF THE PREFERRED EMBODIMENT

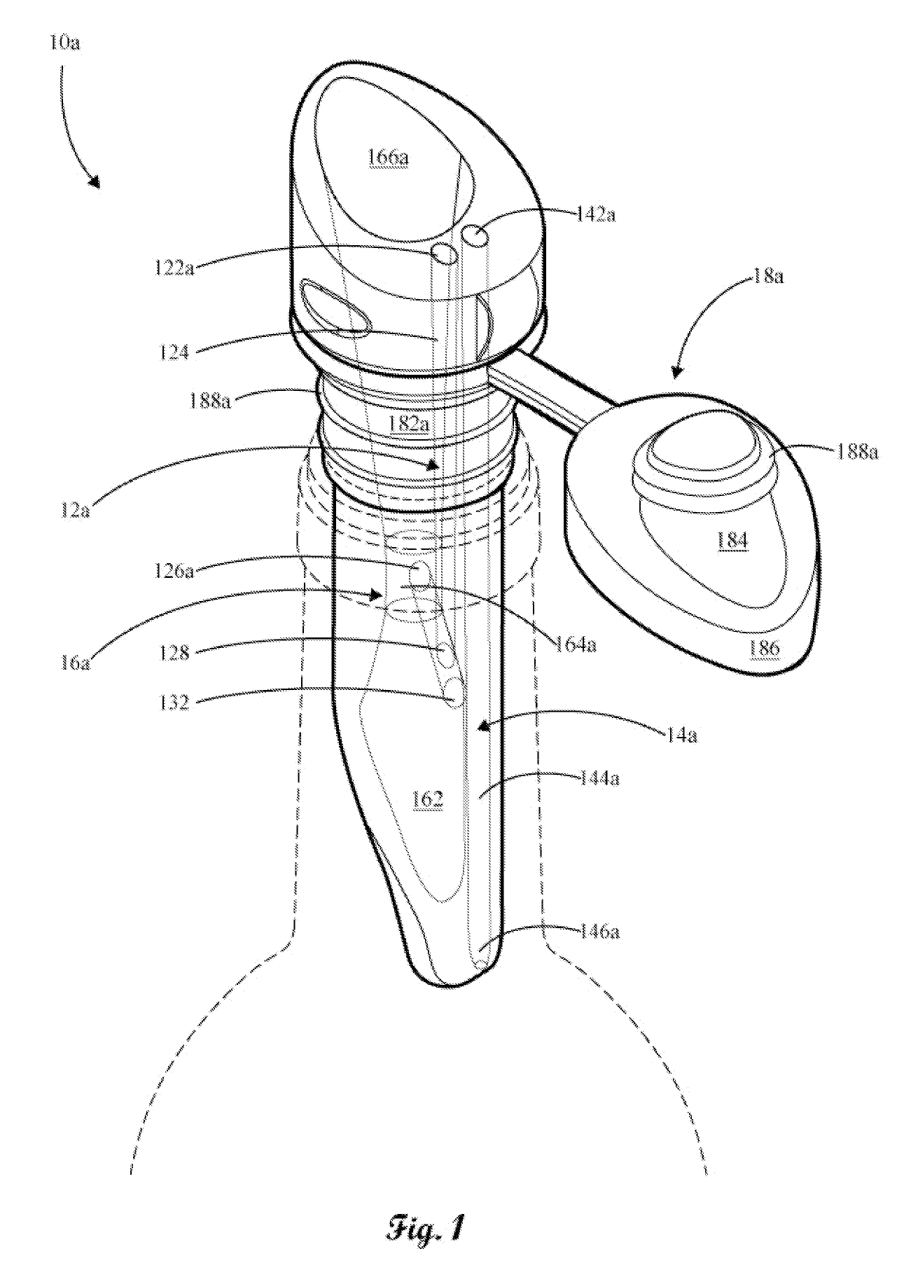

Referring to FIG. 1, an aerating pourer is depicted in its first nonlimiting embodiment includes a housing 10a which defines a passage 16a to accommodate a flow of liquid from inside the bottle (shown in phantom). The defined passage 16a includes a funnel 162 for concentrating a flow of liquid from within the bottle into a constriction that a bowl 164a comprises. Ultimately, the liquid leaves the bowl 164a and enters the horn 166a whose lip is configured to aid pouring into a glass.

The passage 16 comprises, in an order moving from upstream in the bottle to downstream and out of the housing 10a, the funnel 162, the bowl 164a, and the horn 166a. As a liquid flows through the passage 16, the funnel 162, the bowl 164a, and the horn 166a cooperate to form a venturi such that the liquid flow causes a drop, relative to the ambient atmospheric pressure, in the pressure present in the bowl 164a. Exploiting the produced drop in pressure, a barrel 132 conducts air from the ambient into the bowl 164a to mix with the liquid flow to aerate the liquid. Because the air has mass, as the barrel 132 conducts the air into the bowl 164a for mixing, it deflects the liquid flow that produced the drop in pressure.

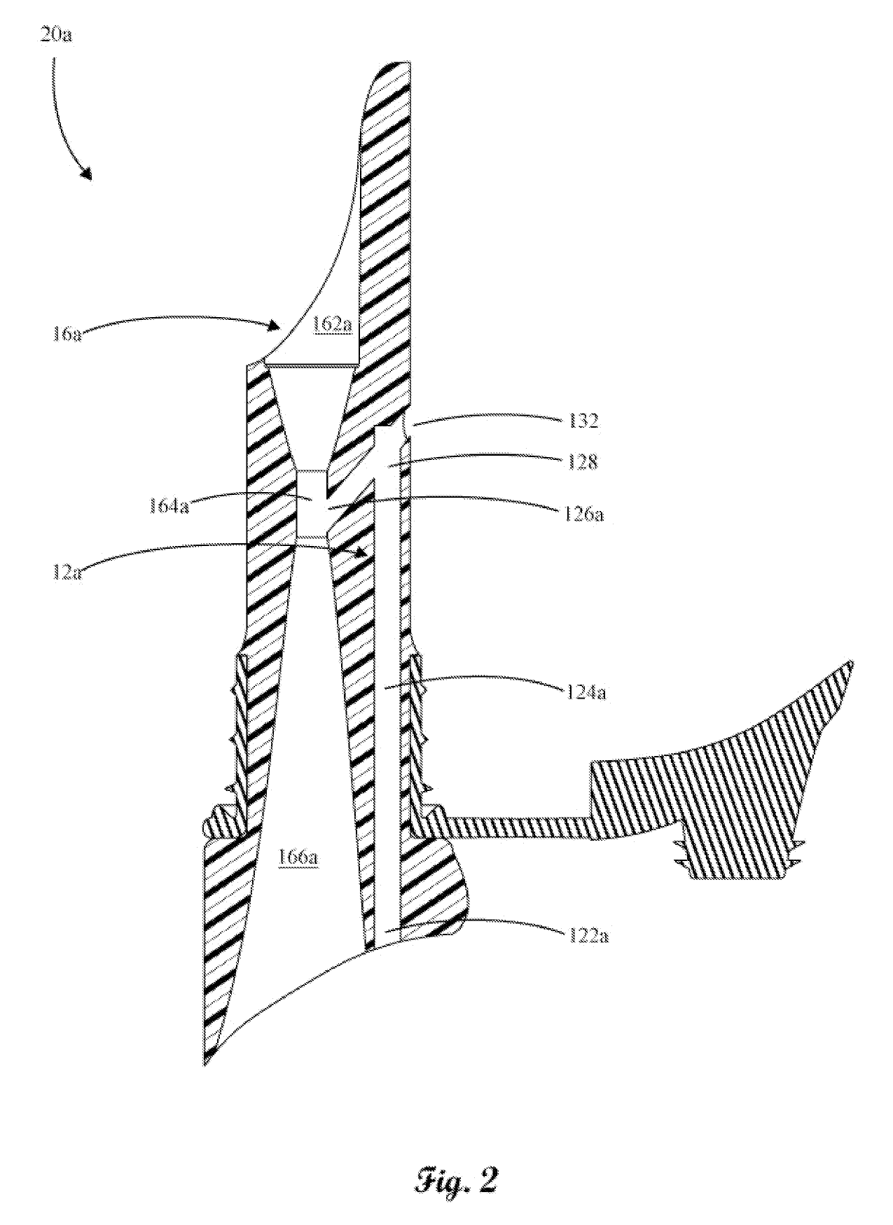

To provide a stream of air in this first embodiment, referring, as well, to FIG. 2, an air supply lumen 124a brings air from an ambient opening 122a through a junction 128 to the barrel 132, for introduction into the bowl 164a at a nozzle 126a. The junction 128 allows orientation of the barrel 132 relative to the liquid flow.

To optimally aerate, the barrel 132, through which the air flows, is set at an acute angle to the liquid flow. Entering the bowl 164a at the nozzle 126a which is directed at an acute angle to the liquid flow, a mass momentum exchange occurs in which the kinetic energy of moving air drives it into the liquid flow to entrain, mix and optimally to expose the liquid to the air for chemical bonding to the tannins Configuration of an interior surface of the bowl 164a may be made to cause further deflection and even turbulence within the flow in order amplify the effect of the air's entry into the liquid flow causing still greater chemical reaction within the bowl 164a.

In contrast to many of the conventional aerators available to date, the instant embodiment is removably fixed in the bottle by a stopper gasket 18 which surrounds the housing 10a to engage an inner surface of a neck of the bottle. To further enhance the sealing of the gasket 18, at least one axial seal flange 188 extend axially from the gasket 18. In practice, this arrangement of flange 188 and gasket 18 has proven to seal in a manner to ensure a complete liquid-tight seal that is easily releasable from the bottle neck with hand pressure.

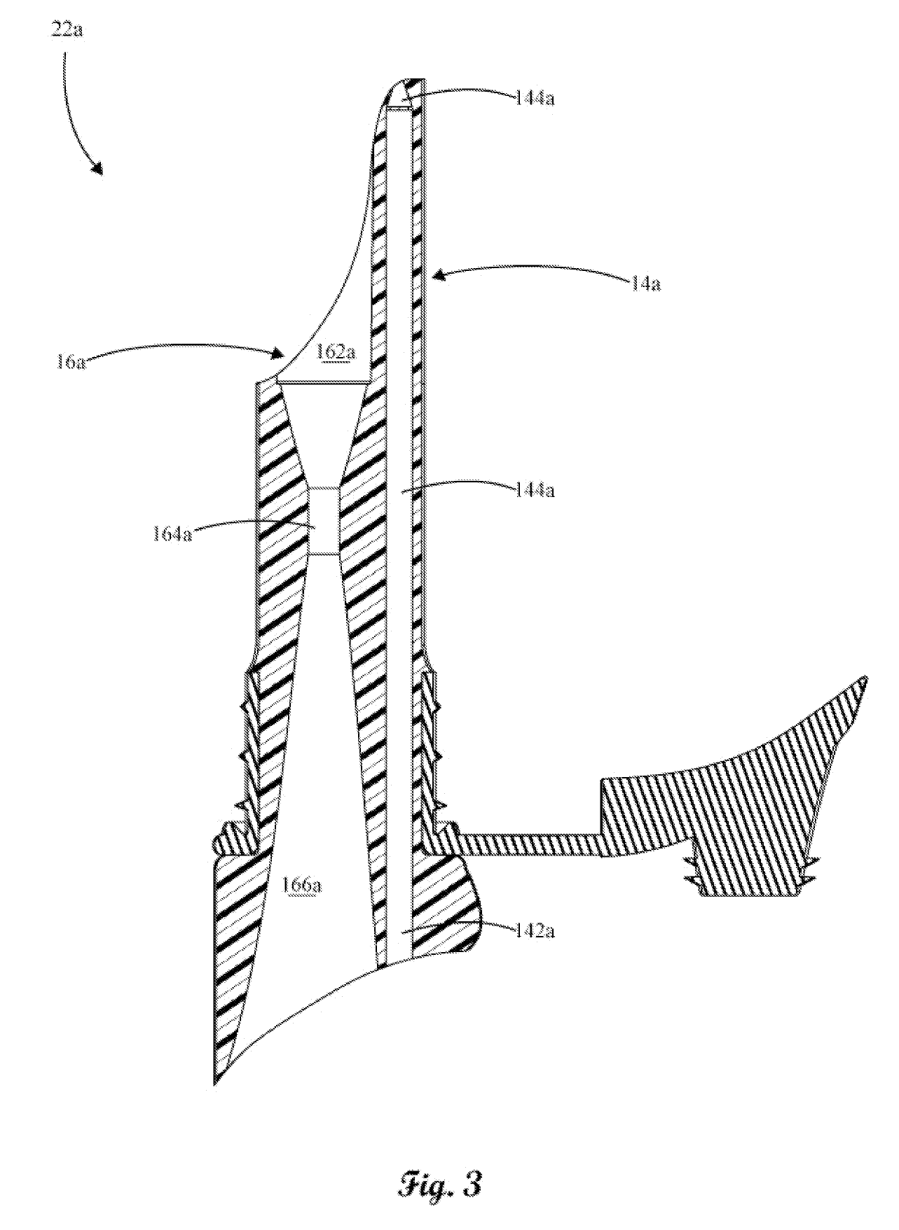

So efficient is the resulting seal, however, that the rush of liquid out of the bottle necessary to create a liquid flow through the passage 16, quickly creates a vacuum in the bottle and, thereby, stops the created liquid flow. Referring now, as well to FIG. 3, in order to assure continued flow through the passage 16a, a vacuum break 14a is necessary. A vacuum break 14a is any air passage that allows the volume of the outflowing liquid to be replaced by air from the ambient atmosphere.

In the presently preferred embodiment, vacuum break 14a includes a vent lumen 144a that extends from an outer vent 142a through the housing 10a, parallel to the passage 16a, and into the interior of the bottle at a bottle-side vent 146a. The barrel 132 provides a second vacuum break using the same vent as supplies the air for mixture in the bowl.

The embodiment also provides an advantageous configuration of the gasket 182 to include a tethered stopper 18a, for completely sealing the first outer vent 142a, the ambient opening 122a, and the horn 166a to allow the pourer housing 10a to function, as well, as a cap to isolate the liquid from further exposure to oxygen in the ambient air. Just as with the gasket 182a, the stopper 18 is formed with at least one axial flange 188a and a protuberance 184 to allow the stopper to extend into the horn 166a when positioned to close the horn 166a. Additionally, a stopping flange 186 both seals the first outer vent 142a, the ambient opening 122a, while providing a handle for removing the stopper 18a from the horn 166a. Because both the gasket 182a and the stopper 16a are advantageously formed of resilient material, the preferred embodiment uses a unitary mold to form each in a single injection. The housing 10a is then inserted into the gasket 182 and oriented to allow the use of the stopper 18a to stop the horn 166a.

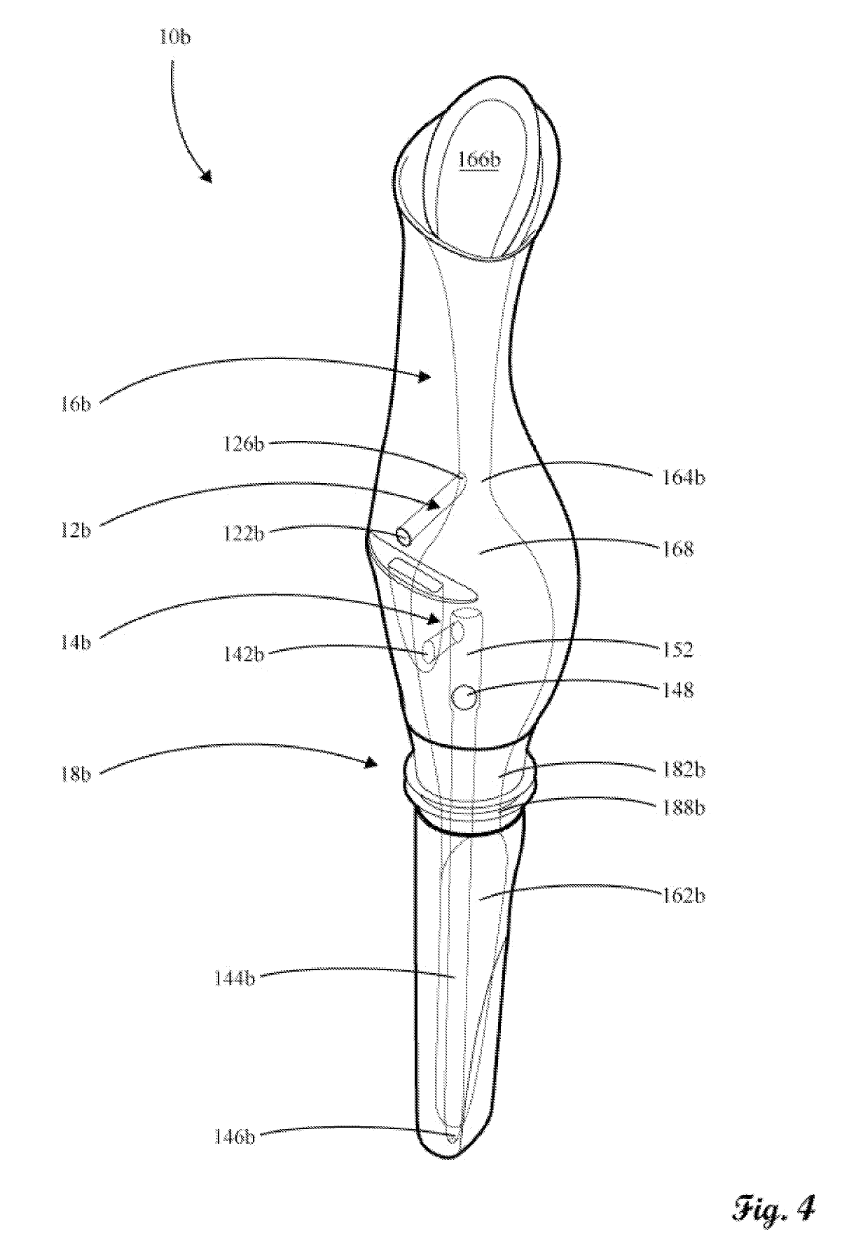

A second embodiment of the housing 10b is portrayed in FIG. 4. Just as in the first embodiment, the second embodiment of the aerating pourer includes a housing 10b which defines a passage 16b to accommodate a flow of liquid from inside the bottle. The defined passage 16b includes a funnel 162b for concentrating a flow of liquid from within the bottle into a constriction that a bowl 164b comprises. Ultimately, the liquid leaves the bowl 164b and enters the horn 166b whose lip is configured to aid pouring into a glass.

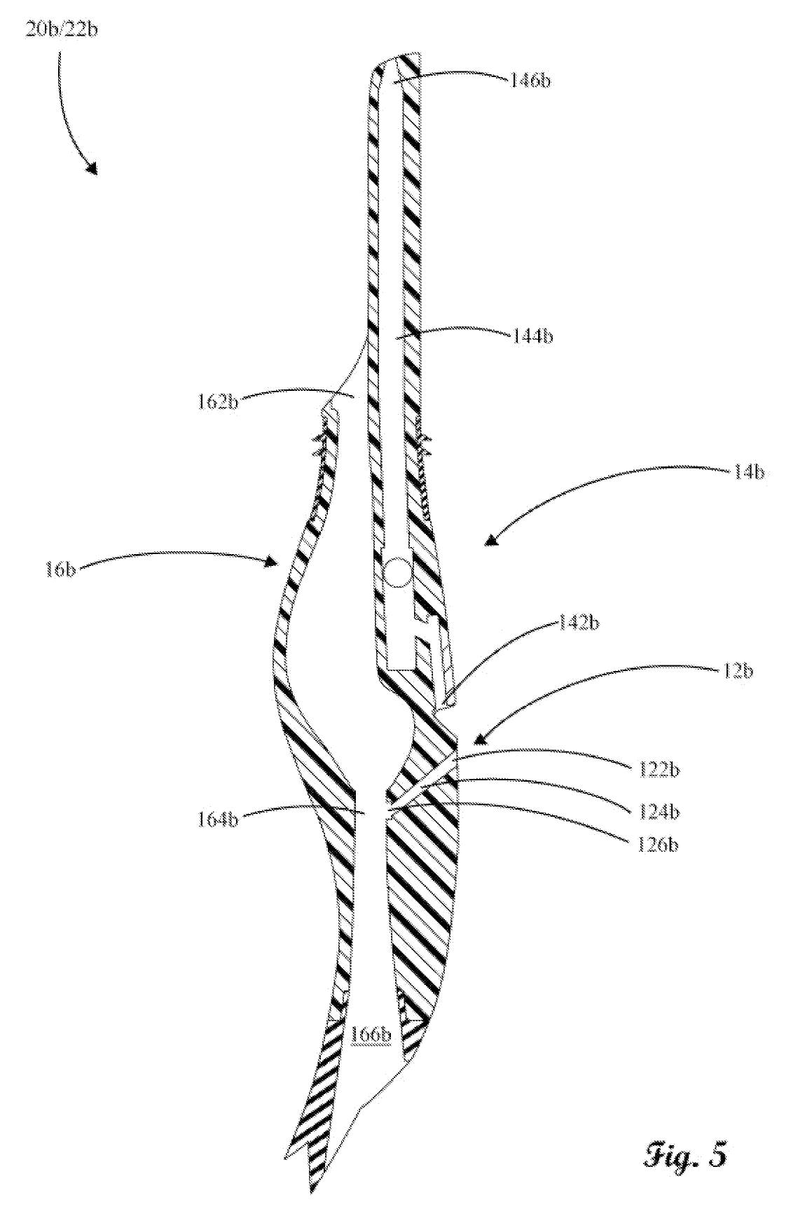

Referring to FIG. 5, the passage 16b comprises, in an order moving from upstream in the bottle to downstream and out of the housing 10b, the funnel 162b, the bowl 164b, and the horn 166b. As a liquid flows through the passage 16b, the funnel 162b, the bowl 164b, and the horn 166b cooperate to form a venturi such that the liquid flow causes a drop, relative to the ambient atmospheric pressure, in the pressure present in the bowl 164b. Exploiting the produced drop in pressure, a barrel 122 conducts air from the ambient at the ambient vent 12b along a lumen 124b into a nozzle 126b, and into the bowl 164b to mix with the liquid flow to aerate the liquid.

The vacuum break 14b is configured to draw air from the ambient at the outer vent 142b through the lumen 144b and out through the bottle-side vent 146b. Unlike the first embodiment, a check ball 148 in the lumen 144b at a ball cage 152 prevents any liquid from flowing backward into the bottle when the bottle is placed in an upright attitude.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An aerator for beverages comprising:
a housing, including
a resilient sealing gasket including at least one annular flange for removable engagement with an opening in a bottle for pouring liquid from the bottle; and
defining a liquid passageway to receive a liquid flow from upstream to downstream along an axis, including:
a funnel coaxially situated to the liquid flow and extending from a funnel inlet converging in a downstream direction at a funnel outlet;
a bowl coaxially situated to the liquid flow and converging in the downstream direction at a bowl outlet in axially spaced downstream relationship to the funnel; and
a horn extending from the bowl outlet and flaring downstream to a horn outlet having a greater cross-sectional area than that of the bowl outlet, the horn coaxially situated to the liquid flow and axially spaced downstream; and
at least one barrel having a barrel lumen extending from a barrel inlet to a barrel outlet at an acute angle to the liquid flow, the barrel inlet being situated to admit an airflow of ambient air from outside of the housing through the lumen and into the bowl, the barrel.

2. The aerator of claim 1 wherein the housing further defines:
a vent lumen for admitting ambient air from outside of the housing into the bottle to facilitate the liquid flow.

3. The aerator of claim 2 wherein the vent lumen includes a check valve configured to prevent the liquid from entering the vent lumen.

4. The aerator of claim 1 wherein the housing further comprises:
a resilient stopper for removable engagement with the horn generally at the horn outlet.

5. The aerator of claim 1 wherein
the housing further defines a vacuum break to allow air to pass from the ambient into the bottle when mounted thereon.

6. The aerator of claim 1 wherein
the funnel includes a liquid strainer such that solids in a flow of liquid admitted into the funnel inlet are retained at the strainer as the liquid flow passes through the funnel outlet into the bowl.

7. The aerator of claim 1 wherein
the bowl is further configured to exploit the kinetic energy of the liquid flow to create perturbation bringing about more complete mixing of the air and liquid the liquid flow comprises.

8. A method for introduction of ambient air through a beverage aerator defining a venturi and mounted upon a bottle comprises:
rotating the bottle to initiate a liquid flow through the venturi to induce a localized drop in pressure at a bowl situated at a venturi throat within the venturi;
admitting an airflow initiating at a barrel inlet;
mixing the liquid and airflows immediate to the venturi throat to produce an aerated liquid; and
admitting a flow of air from the ambient into the bottle through a vacuum break the housing defines.

9. The method of claim 8 further comprising
discharging a flow of aerated liquid from a horn.

10. The method of claim 9 further comprising
rotating bottle into a substantially vertical orientation; and
inserting a stopper into the horn to seal the bottle against incursion of ambient air.

11. An aerator for beverages comprising:
a housing, defining a liquid passageway to receive a liquid flow from upstream to downstream along an axis, including:
a funnel coaxially situated to the liquid flow and extending from a funnel inlet converging in a downstream direction at a funnel outlet;
a bowl coaxially situated to the liquid flow and converging in the downstream direction at a bowl outlet in axially spaced downstream relationship to the funnel;
a horn extending from the bowl outlet and flaring downstream to a horn outlet having a greater cross-sectional area than that of the bowl outlet, the horn coaxially situated to the liquid flow and axially spaced downstream; and
at least one barrel having a barrel lumen extending from a barrel inlet to a barrel outlet at an acute angle to the liquid flow, the barrel inlet being situated to admit an airflow of ambient air from outside of the housing through the lumen and into the bowl; and
a resilient stopper means configured to selectably sealingly engage the horn and barrel lumen; and
a resilient sealing gasket including at least one annular flange for removable engagement with an opening in a bottle for pouring liquid from the bottle.

12. The aerator of claim 11 wherein the housing further defines:
at least one vent lumen for admitting ambient air from outside of the housing into the bottle to facilitate the liquid flow, the vent lumen being sealed by the resilient stopper when the horn and barrel are sealingly engaged.

13. The aerator of claim 12 wherein the vent lumen includes a check valve configured to prevent the liquid from entering the vent lumen.

14. The aerator of claim 11 wherein the barrel joins one of the at least one vent lumens.

15. The aerator of claim 11 wherein
the funnel includes a liquid strainer such that solids in a flow of liquid admitted into the funnel inlet are retained at the strainer as the liquid flow passes through the funnel outlet into the bowl.

16. The aerator of claim 11 wherein
the bowl is further configured to exploit the kinetic energy of the liquid flow to create perturbation bringing about more complete mixing of the air and liquid the liquid flow comprises.
